(19) United States
(12) Patent Application Publication
(10) Pub. No.: US 2017/0133983 A1
(43) Pub. Date: May 11, 2017

(54) ELECTROLUMINESCENCE TESTABLE PHOTOVOLTAIC MODULES HAVING SHADE MANAGEMENT SOLUTIONS

(71) Applicant: Solexel, Inc., Milpitas, CA (US)

(72) Inventors: Mehrdad M. Moslehi, Milpitas, CA (US); Peter Park, Milpitas, CA (US); Hien M. Nguyen, Milpitas, CA (US); Steve J. Coonen, Milpitas, CA (US); Gene Choi, Milpitas, CA (US)

(21) Appl. No.: 15/172,146

(22) Filed: Jun. 2, 2016

Related U.S. Application Data
(60) Provisional application No. 62/170,100, filed on Jun. 2, 2015.

(51) Int. Cl. H02S 50/15; H02S 40/30

(52) U.S. Cl. CPC H02S 50/15; H02S 40/30

(57) ABSTRACT

A photovoltaic module structure comprises a photovoltaic power generator of at least one solar cell, the photovoltaic power generator having a positive and a negative output terminal. A forward biased blocking diode electrically connected in parallel with a magnetically actuated normally-open bypass switch, the forward biased blocking diode and the magnetically actuated normally-open bypass switch electrically connected in series to the positive output terminal or the negative output terminal of the photovoltaic power generator. A module output terminal electrically connected as the output to the forward biased blocking diode and the magnetically actuated normally-open bypass switch. The photovoltaic power generator, the forward biased blocking diode, and the magnetically actuated normally-open bypass switch embedded within a module laminate.

### CROSS-REFERENCE TO RELATED APPLICATIONS

This application claims the benefit of U.S. provisional patent application 62/170,100 filed on Jun. 2, 2015, which is hereby incorporated by reference in its entirety.

### FIELD OF THE INVENTION

The present disclosure relates in general to the fields of solar photovoltaics (PV), and more particularly to solar photovoltaic module structures and fabrication methods.

### BACKGROUND

Electroluminescence (EL) testing and measurement of photovoltaic solar cells and modules is based on the same phenomenon as light-emitting diode (LED). Using an external power supply, electrical current flows through the solar cell which is a pn junction diode or through the solar module which is an array of series-connected pn junction solar cells, in forward-bias mode. EL testing may be typically performed with current ranging from approximately 10% of the module I_{sc} to greater than the module I_{sc} value. An EL measurement typically takes less than one second.

Radiative recombination of electron-hole pairs results in light emission. Since silicon is an indirect bandgap semiconductor, most of the carrier recombination in silicon occurs through defects and Auger recombination. The extent of band-to-band recombination resulting in radiative emission is relatively small but can be sensed using a sensitive EL camera. In EL imaging, the light emission intensity is proportional to the voltage, so poorly contacted and inactive regions show as dark and good regions show as bright areas.

However, shade management solutions utilizing components such as blocking diodes often limit or outright prevent photovoltaic module EL testability as the component may be designed to prevent reverse current flow back to the module for improved system performance and enhanced safety.

### BRIEF SUMMARY OF THE INVENTION

Therefore, a need has arisen for an electroluminescence (EL) testable photovoltaic module having shade management solutions. In accordance with the disclosed subject matter, photovoltaic module structures are provided which may substantially eliminate or reduces disadvantage and deficiencies associated with previously developed photovoltaic module structures.

According to one aspect of the disclosed subject matter, an impact resistant light weight photovoltaic module is provided. A photovoltaic module structure comprises a photovoltaic power generator of at least one solar cell, the photovoltaic power generator having a positive and a negative output terminal. A forward biased blocking diode electrically connected in parallel with a magnetically actuated normally-open bypass switch, the forward biased blocking diode and the magnetically actuated normally-open bypass switch electrically connected in series to the positive output terminal or the negative output terminal of the photovoltaic power generator. A module output terminal electrically connected as the output to the forward biased blocking diode and the magnetically actuated normally-open bypass switch. The photovoltaic power generator, the forward biased blocking diode, and the magnetically actuated normally-open bypass switch embedded within a module laminate.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims.

### BRIEF DESCRIPTION OF THE DRAWINGS

The features, natures, and advantages of the disclosed subject matter may become more apparent from the detailed description set forth below when taken in conjunction with the drawings in which like reference numerals indicate like features and wherein:

FIG. 1 is a diagram of an electroluminescence (EL) testable photovoltaic module.

FIG. 2 is a diagram of an electroluminescence (EL) testable photovoltaic module consistent with the module of FIG. 1 and having a second forward biased blocking diode;

FIG. 3 is a diagram of an electroluminescence (EL) testable photovoltaic module and

FIG. 4 is a diagram of an electroluminescence (EL) testable photovoltaic module.

### DETAILED DESCRIPTION

The following description is not to be taken in a limiting sense, but is made for the purpose of describing the general principles of the present disclosure. The scope of the present disclosure should be determined with reference to the claims. Exemplary embodiments of the present disclosure are illustrated in the drawings, like aspects and identifiers being used to refer to like and corresponding parts of the various drawings.

And although the present disclosure is described with reference to specific embodiments, components, and materials, such as electronic components (e.g., magnetically actuated normally open bypass switches such as reed switches and surface mount devices) and module laminates (transparent or otherwise), one skilled in the art could apply the principles discussed herein to other solar module structures, fabrication processes, as well as alternative technical areas and/or embodiments without undue experimentation.

Comprehensive solutions for electroluminescence (EL) module measurement of photovoltaic module structures through laminated embedded parallel connected electrical components are provided. Magnetically actuated normally open bypass switches, for example and as described with detail herein as reed switches, are connected in parallel with blocking diodes for EL testing and to preserve the functionality of the blocking diode during and after EL testing.

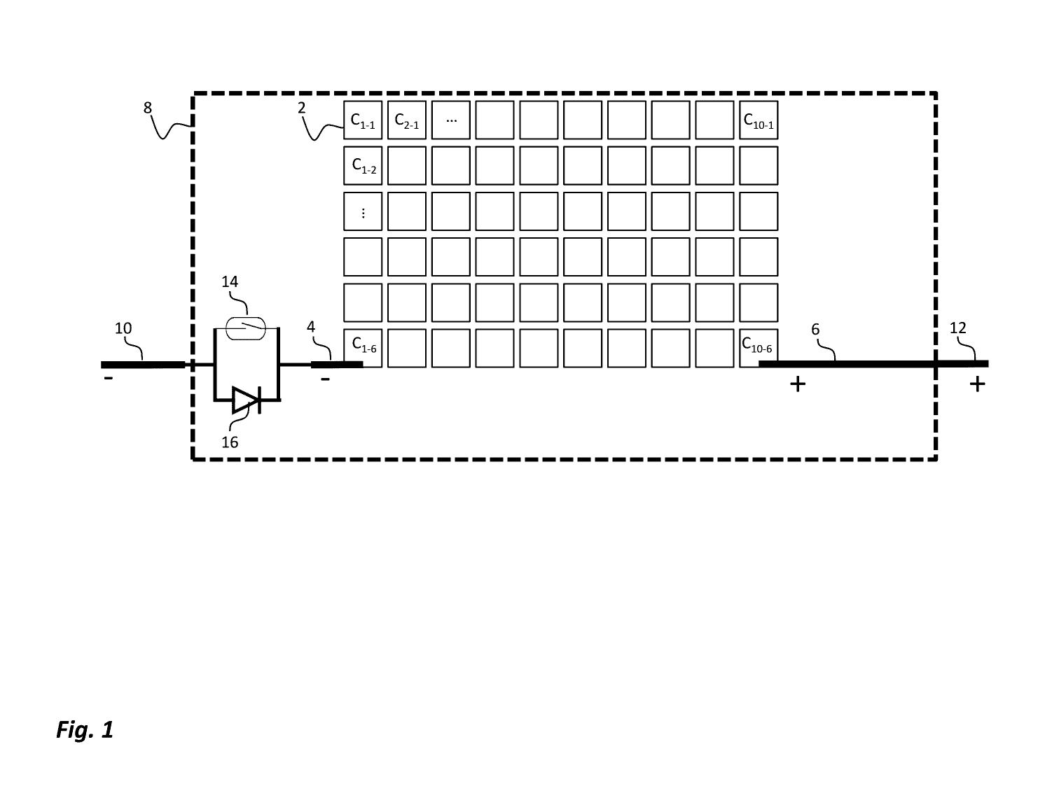

FIG. 1 is a diagram of an electroluminescence (EL) testable photovoltaic module. Solar cells C₁₋₁ through C₁₀₋₆ (e.g., solar cells electrically connected in series) form photovoltaic power generator 2 having negative output terminal 4 and positive output terminal 6. Positive output terminal 6 is connected to positive module output terminal 12. Negative output terminal 4 is connected to forward biased blocking diode 16 and normally-open reed switch 14 which are connected in parallel. Forward biased blocking diode 16 and normally-open reed switch 14 are connected to negative module output terminal 10. Photovoltaic power generator 2, negative output terminal 4, positive output terminal 6, forward biased blocking diode 16, and normally-open reed switch 14 are embedded within module laminate 8. Negative module output terminal 10 and positive module output terminal 12 provide for power transfer outside of the photovoltaic module and thus may be fully or partially embedded in the module laminate or not embedded in the module laminate at all (e.g., in the instance the electrical output of the forward biased blocking diode and the normally-open reed switch are positioned at the edge of the module laminate).

In another embodiment forward biased blocking diode 16 and normally-open reed switch 14 may be connected to positive output terminal 6 and positive module output terminal 12 instead of connected to negative output terminal 4 negative module output terminal 10.

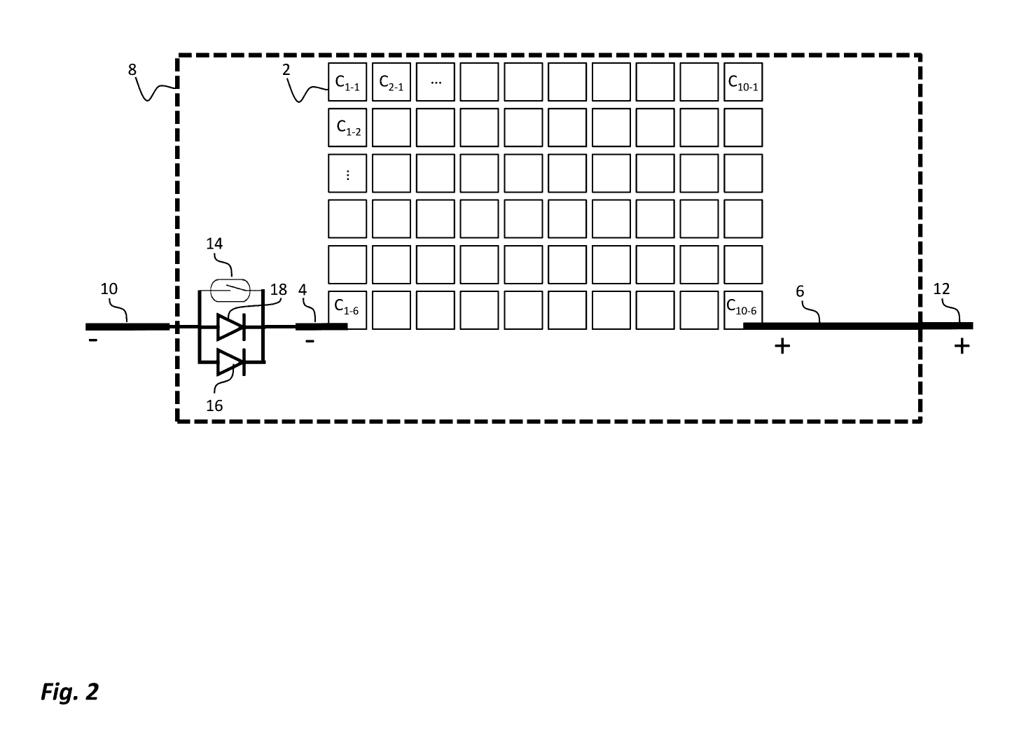

FIG. 2 is a diagram of an electroluminescence (EL) testable photovoltaic module consistent with the module of FIG. 1 and having a second forward biased blocking diode, forward biased blocking diode 18, connected in parallel with forward biased blocking diode 16 and normally-open reed switch 14.

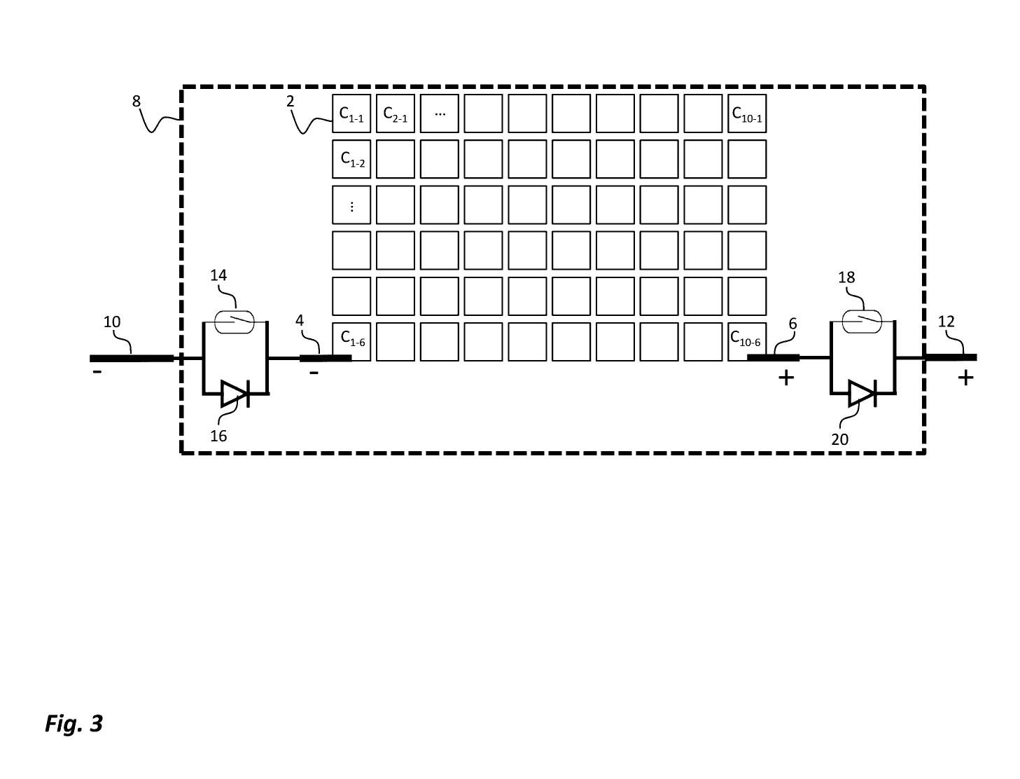

FIG. 3 is a diagram of an electroluminescence (EL) testable photovoltaic module consistent with the module of FIG. 1 and having positive output terminal 6 connected to forward biased blocking diode 20 and normally-open reed switch 18 which are connected in parallel. Forward biased blocking diode 20 and normally-open reed switch 18 are connected to negative module output terminal 12.

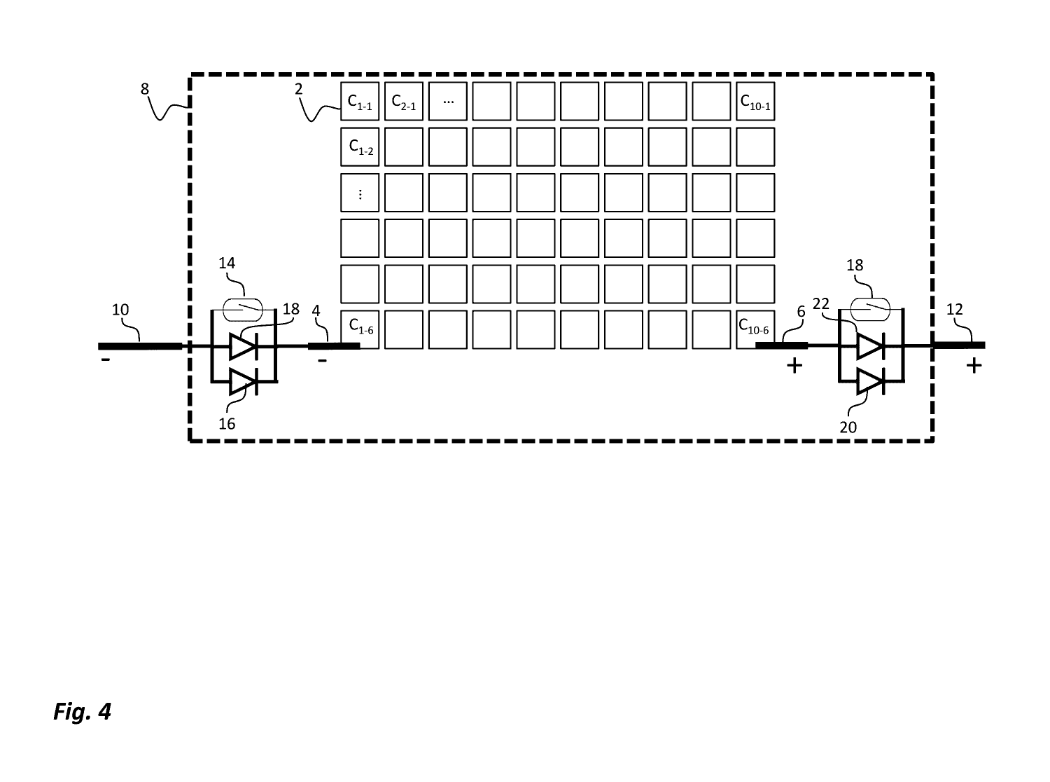

FIG. 4 is a diagram of an electroluminescence (EL) testable photovoltaic module consistent with the module of FIG. 3 and having both a forward biased blocking diode 18 connected in parallel with forward biased blocking diode 16 and normally-open reed switch 14 and a forward biased blocking diode 22 connected in parallel with forward biased blocking diode 20 and normally-open reed switch 18.

The electroluminescence (EL) testable photovoltaic module solutions provided have a minimum of one blocking diode (e.g., a suitable Schottky barrier diode or a pn junction diode or another rectifier such as a transistor-based rectifier) connected in electrical parallel with a Normally-Open (NO) reed relay switch, with this pair of blocking diode and NO reed relay switch connected in series with one of the module terminals, such that the blocking diode is forward biased enabling the module photo-generated current to pass through the diode during normal module operation. Both components (diode and reed switch) may be advantageously embedded in the module laminate. For fault tolerance and added reliability, two blocking diodes may be connected in parallel with each other and the reed relay switch, with this 3-part parallel-connected array connected in series with the module terminal. And for further enhanced fault tolerance, a similar parallel-connected array of 3 parts (2 diodes and 1 Reed switch) may be connected in electrical series with the other (opposite polarity) module terminal as well.

The photovoltaic power generator may comprise any number of solar cells (e.g., from one cell to many such as 60) and also may be electrically connected in series, parallel, or combinations of series and parallel in order to scale the voltage and current of the photovoltaic power generator (e.g., scaling using a reduced number of cells). Alternatively, photovoltaic modules with a plurality (e.g., 12, 60, 72, 90, 96, 120, etc.) of solar cells with each solar cell optionally partitioned (either by breakage of each cell into multiple series-connected subcells, or by monolithically partitioned subcells) to scale up the voltage and scale down the current may provide advantageous scaling of the module current and voltage (resulting in scaled-down module current and scaled-up module voltage) resulting in reduced module current by a factor of N≧2, and increased module voltage by a factor of N≧2 (compared to the conventional modules without intra-module current and voltage scaling). Typical N values may be integers (preferably even integers) between 2 to 16 (for instance, N may be 4, 8, or 12). Reduced module current by a factor of N (e.g., preferably N in the range of 4 to 12) may result in substantially reduced I².R ohmic losses and also I.V_{f} power dissipation in a blocking diode (I and V_{f} are the module current and the forward-bias voltage of the blocking diode, respectively). For instance, for a crystalline silicon 60-cell PV module with STC power of more than 300 W and N=12 (e.g., subcells with N=12), the STC maximum-power current of the module may be Iₘₚ≈0.75 A. A blocking diode with V_{f}≈0.6 V will result in about 0.75 A×0.6 V=0.45 W of power dissipation—a highly acceptable value as it is <0.15% of the module STC power. This relatively small value enables implementation of a blocking diode as an embedded component within the PV module laminate. Thermal management of such relatively small maximum power loss for an embedded blocking diode is quite feasible without any detrimental impact on module reliability.

For a parallel-connected architecture (connections of PV modules, advantageously PV modules with scaled down current and scaled up voltage values, in parallel, with all positive module terminals connected together for the positive DC terminal connected to the load such as inverter positive input, and with all negative module terminals connected together for the negative DC terminal connected to the load such as inverter negative input), embedded blocking diodes enable maximum power delivery from the parallel-connected PV array for all shading and soiling conditions. For instance, a heavily shaded or soiled module with excessively reduced photo-generated module voltage would not compromise the power delivery of the other modules on a parallel-connected array. An inverter MPPT may set the DC rail voltage at a value for maximum PV system power and if a heavily shaded module cannot keep up with the rail voltage, the embedded blocking diodes are simply reverse biased, hence, effectively decommissioning the heavily shaded module from the array until it can provide sufficient power and voltage again.

The embedded blocking diodes also protect each module by preventing reverse current flow. For instance, if a module is heavily shaded and the load (e.g., inverter) is disconnected from a parallel-connected PV array, there would be a large reverse current flow through the heavily shaded module if no blocking diodes are used (resulting in potential module failure and fire hazard). Using the embedded blocking diodes prevents this mode of module failure due to reverse current flow.

Embedded blocking diodes enable a parallel-connected PV architecture, with the PV array comprising a parallel-connected array of PV modules that advantageously may have each module having scaled-down current and scaled up voltage values, and with each module having embedded blocking diodes.

In conjunction with the PV array transient voltage suppressor (TVS), the embedded blocking diodes also provide some level of module protection against electrostatic and lightning surges.

In order to provide improved fault-tolerance against various modes of failure, two blocking diodes may be connected in series with one of the module terminals or two pairs of parallel-connected blocking diodes with each pair of parallel-connected blocking diodes may be connected in series with one of the module terminals (positive and negative terminals).

As solar cells in the solar module must be forward biased with the external current flowing for El testing, the embedded blocking diodes must be shunted in order to allow the current flow during EL testing. Connected in parallel with each pair of blocking diodes is a Normally Open reed switch connected.

For example, in normal mode of module operation and power delivery and in absence of any failures, all four diodes (two on each terminal) are forward-biased and allow the module current to pass through them. In case the external module leads are subjected to a voltage which is higher than the module voltage (plus the forward-bias voltages of the diodes), all four blocking diodes are reverse biased and protect the module from the over-voltage condition.

If a single blocking diode fails and the failure causes an electrical short, the blocking diodes on the opposite polarity terminal will continue to provide the blocking diode function. Similarly, if both parallel-connected diodes on a terminal fail and cause an electrical short, the blocking diodes on the opposite polarity terminal will continue to provide the blocking diode function.

A Normally-Open (NO) reed relay switch is used in parallel with each blocking diode (or with each pair of blocking diodes when using a fault-tolerant design with redundancy). In normal mode of PV module operation (when producing solar power), the reed switch remains open and the solar-generated current passes through the forward-biased blocking diodes, delivering power to the load. In an advantageous embodiment, the reed switches and blocking diodes are all embedded in PV module

In order to enable electroluminescence (EL) testing of the PV module, the reed relay switches are activated and closed (using either a permanent magnet or an electromagnet), shunting or bypassing the two pairs of blocking diodes connected on both positive and negative terminals of the module. Then the EL testing is performed (with the closed reed switches allowing the EL current to pass through the module in the desired direction which is opposite the direction of the module current during normal operation). After completion of EL testing, the sources of magnetic actuation (either permanent magnets or electromagnets) are removed, returning the reed switches into their normally open state. Thus, in normal PV module operation, the reed switches remain open and do not have any functional impact on the normal operation of the blocking diodes, with the blocking diodes guiding the module current in their forward-bias state.

In one embodiment, a minimum parts-count design uses one blocking diode in parallel with one Normally-Open (NO) Reed switch, with the pair attached in series with one of the module terminals (positive or negative). This design has no fault tolerance and in case of a single part failure, its main function will be compromised.

An advantageous design provides embedded components of two pairs of parallel-connected blocking diodes (with fault-tolerance redundancy—using four high-voltage blocking diodes instead of one), with each pair of blocking diode connected in parallel with one Normally-Open (NO) reed switch. Each set of three parallel-connected parts (i.e., two blocking diodes and a reed switch) is then connected in series with one of the PV module terminals (positive and negative).

For electroluminescence (EL) testability, a normally-open magnetic reed switch is connected in parallel with each pair of blocking diodes. For EL testing, the magnetic switches are closed by using permanent magnets or electromagnets to allow current flow against the forward-bias direction of blocking diodes.

As a representative example of using electromagnets for reed switch closure for electroluminescence (EL) testing of solar modules comprising embedded blocking diodes and reed switches:

1. Affix two electromagnets to the solar module (frontside or backside) in preparation for EL testing: one electromagnet with its position overlapping with each embedded reed switch position. The use of two electromagnets applies to the module design wherein there is at least one blocking diode (or advantageously two parallel-connected blocking diodes) connected in parallel with a Normally-Open (NO) reed switch in association with each terminal of the module and the positions of these embedded parts for the two terminal polarities are separate by an appreciable distance (e.g., at two separate corners or sides of the module).

2. Use a multi-output power supply with two isolated power supply outputs connected to the two electromagnets and a third output connected to the module positive and negative terminals. Alternatively, use three separate power supplies, with two supplies attached to the two electromagnets and a third power supply attached to the module main terminals. The power supplies are controlled by a master controller (e.g., a computer).

3. Based on a pre-designed timing sequence, the following sequence is applied: (i) Apply electrical current to both electromagnets to actuate and close the reed switches while the module power supply remains off (or its voltage and current are zero); (ii) Then, while the reed switches are closed using the electromagnet actuators, flow forward-bias current into the PV module using the module power supply and complete the EL testing; (iii) turn off the main module power supply (with its voltage and current going back to zero); (iv) After the main module power supply is turned off, turn off the electromagnet power supplies; (v) Finally, detach the power supplies and remove the electromagnets from the module.

The above-mentioned sequence enables EL testing of the solar PV module in a safe mode. The reed switches are only actuated when there is no current flow through the module.

Desired characteristics of the blocking diodes include: relatively small power dissipation (advantageously P_{D}≦0.5 W) at maximum module current of I_{sc} (e.g., at I_{sc}≈0.8 A for modules with 12× current and voltage scaling); forward-bias current rating (including derating at high operating temperatures) larger than the maximum module current of I_{sc} with sufficient margin (e.g., temperature-derated forward-bias current rating larger than I_{sc} at least by a factor of 2×; low reverse-bias leakage current at system voltage over the entire range of PV system operating temperatures (e.g., reverse leakage <<0.1 mA at up to 600 V); sufficiently large reverse breakdown voltage (V_{BR}), larger than the maximum system voltage by a good margin (e.g., V_{BR}≧750 V for maximum system voltage of 600 V); low-profile Surface-Mount Device (SMD) diode package to facilitate embedded implementation within the PV module laminate; reliable over extended operating temperature range (e.g., −65° C. to +155° C.); and, relatively low cost (e.g., ≦$0.10 per part).

Desired characteristics of the reed switches include: relatively small maximum static contact resistance (e.g., Rₘₐₓ≦0.2 ohm); sufficiently large carry current rating, advantageously larger than the maximum module current of I_{sc} with sufficient margin (e.g., carry current ≈1 A for modules with 12× current and voltage scaling); low reverse-bias leakage current at system voltage over the entire range of PV system operating temperatures (e.g., reverse leakage <<0.1 mA at up to 600 V); sufficiently large minimum breakdown voltage (V_{BD-min}), for example, V_{BD-mm}≧300 V; relatively low-profile Surface-Mount Device (SMD) Reed switch package to facilitate embedded implementation within the PV module laminate; reliable over extended operating temperature range (e.g., −40° C. to +130° C.); mechanical shock and vibration resistance (e.g., ≧20 g); and, relatively low cost (e.g., ≦$0.30 per part). An example of a suitable part for embedded reed switches includes a magnetically-operated, open Reed (Normally Open), proximity switch for SMD mounting with no external power is required for switch operation.

Additional embodiments may utilize a transient voltage suppressor (TVS) (e.g., electrically connected in parallel with module string inverter/load). A TVS is a device which provides protection against sudden or momentary overvoltage or voltage surge conditions. Examples include Zener diode and Metal-Oxide Varistor (MOV). Typical TVS devices respond to voltage surges or over-voltage conditions much faster than other overvoltage protection components such as other varistors or gas-discharge tubes or fuses. TVS provides excellent protection against very fast and often damaging voltage spikes. These fast voltage spikes or over-voltage conditions may be caused by a variety of either internal or external events, such as lightning or arcing.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A photovoltaic module structure, comprising:
a photovoltaic power generator of at least one solar cell, said photovoltaic power generator having a positive and a negative output terminal;
a forward biased blocking diode electrically connected in parallel with a magnetically actuated normally-open bypass switch, said forward biased blocking diode and said magnetically actuated normally-open bypass switch electrically connected in series to the positive output terminal or the negative output terminal of said photovoltaic power generator;
a module output terminal electrically connected as the output to said forward biased blocking diode and said magnetically actuated normally-open bypass switch; and
said photovoltaic power generator, said forward biased blocking diode, and said magnetically actuated normally-open bypass switch embedded within a module laminate.

2. The photovoltaic module structure of claim 1, further comprising:
a second forward biased blocking diode electrically connected in parallel with said blocking diode and said magnetically actuated normally-open bypass switch; and
said second forward biased blocking diode embedded within said module laminate.

3. The photovoltaic module structure of claim 1, wherein said magnetically actuated normally-open bypass switch is a normally-open reed switch.

4. The photovoltaic module structure of claim 1, wherein said blocking diode is a Schottky barrier diode.

5. The photovoltaic module structure of claim 1, wherein said blocking diode is a pn junction diode.

6. The photovoltaic module structure of claim 1, wherein said blocking diode is a transistor based rectifier.

7. A photovoltaic module structure, comprising:
a photovoltaic power generator of at least one solar cell, said photovoltaic power generator having a positive and a negative output terminal;
a positive output terminal forward biased blocking diode electrically connected in parallel with a positive output magnetically actuated normally-open bypass switch, said positive output terminal forward biased blocking diode and said positive output terminal magnetically actuated normally-open bypass switch electrically connected in series to the positive output terminal of said photovoltaic power generator;
a negative output terminal forward biased blocking diode electrically connected in parallel with a negative output magnetically actuated normally-open bypass switch, said negative output terminal forward biased blocking diode and said negative output terminal magnetically actuated normally-open bypass switch electrically connected in series to the negative output terminal of said photovoltaic power generator;
a positive module output terminal electrically connected as the output to said positive output terminal forward biased blocking diode and said positive output terminal magnetically actuated normally-open bypass switch;
a negative module output terminal electrically connected as the output to said negative output terminal forward biased blocking diode and said negative output terminal magnetically actuated normally-open bypass switch;
said photovoltaic power generator, said positive output terminal forward biased blocking diode, said positive output terminal magnetically actuated normally-open bypass switch, said negative output terminal forward biased blocking diode, and said negative output terminal magnetically actuated normally-open bypass switch embedded within a module laminate.

8. The photovoltaic module structure of claim 6, further comprising:
a second positive output terminal forward biased blocking diode electrically connected in parallel with said positive output terminal forward biased blocking diode and said positive output magnetically actuated normally-open bypass switch; and
a second negative output terminal forward biased blocking diode electrically connected in parallel with said negative output terminal forward biased blocking diode and said negative output magnetically actuated normally-open bypass switch; and,
said second positive output terminal forward biased blocking diode and said second negative output terminal forward biased blocking diode embedded within said module laminate.

9. The photovoltaic module structure of claim 7, wherein said negative output terminal magnetically actuated normally-open bypass switch and said positive output terminal magnetically actuated normally-open bypass switch are normally-open reed switches.

10. A method for the electroluminescence (EL) testing of a photovoltaic solar module structure, comprising:
applying an electromagnet to the magnetically actuated normally-open bypass switch in a photovoltaic module structure, said photovoltaic module structure comprising:
a photovoltaic power generator of at least one solar cell, said photovoltaic power generator having a positive and a negative output terminal;
a forward biased blocking diode electrically connected in parallel with a magnetically actuated normally-open bypass switch, said forward biased blocking diode and said magnetically actuated normally-open bypass switch electrically connected in series to the positive output terminal or the negative output terminal of said photovoltaic power generator;
a module output terminal electrically connected as the output to said forward biased blocking diode and said magnetically actuated normally-open bypass switch;
said photovoltaic power generator, said forward biased blocking diode, said magnetically actuated normally-open bypass switch, embedded within a module laminate;
apply electrical current to said electromagnet to actuate and close said magnetically actuated normally-open bypass switch while the voltage and current of the module are zero;
flow forward-bias current into the photovoltaic module structure and perform the EL testing while said magnetically actuated normally-open bypass switch is closed;
stop flowing forward-bias current into said photovoltaic module structure; and
stop applying electrical current to said electromagnet.
